(19) United States
(12) Patent Application Publication
(10) Pub. No.: US 2002/0097159 A1
(43) Pub. Date: Jul. 25, 2002

(54) System and method using medical information-containing electronic devices

(76) Inventor: Peter Hooglander, Ronkonkoma, NY (US)

Correspondence Address: CLARK & BRODY, Suite 600, 1750 K Street, NW, Washington, DC, 20006, US

(21) Appl. No.: 10/044,976

(22) Filed: Jan. 15, 2002

Related U.S. Application Data
(60) Provisional application No. 60/262,370, filed on Jan. 19, 2001.

(51) Int. Cl. G08B 23/00

(52) U.S. Cl. 340/573.1; 340/540

(57) ABSTRACT

A system and method for providing medical information in an emergency comprises a pair of cards, each having an electronic device thereon. One large card is used both for home and medical visits, with a smaller card carried on one's person for medical emergencies. Readers are provided at home and at places where medical services may be provided to maintain both cards in a current state. Other portable readers are provided for reading in at least emergency situations, including reading both types of cards and transmitting signals as part of the reading step.

This application claims priority under 35 USC 119(e) based on provisional application no. 60/262,370 filed on Jan. 19, 2001.

### FIELD OF THE INVENTION

The present invention is directed to a system and method using medical information-containing electronic devices, wherein a pair of electronic smart cards is utilized with the appropriate reading stations to allow the smart cards to be used in both non-emergency and emergency situations.

### BACKGROUND ART

Statistics are clearly showing a large number of medical mistakes in treatment and/or time span during emergency situations. These mistakes result from lack of needed information given from the patient or victim to the medical personnel at the scene of the accident or the emergency room. These mistakes especially occur in emergencies where the patient is incoherent and/or cannot provide vital personal and/or medical data to the appropriate person, i.e., incapacitated.

Besides the need to obtain the proper information about a victim, another problem facing accident victims is the time lapse before a victim receives emergency treatment, i.e., the “pre-hospital stage” of any injured person. From the start-time of impact to the victim (car-accident, fall of an elderly person in a store, child hit by car, etc.) until the time their medical situation is under control by emergency crews, paramedics, or hospital personnel or the like, many minutes, crucial for the patient's survival, are lost and many mistakes can be unfortunately made during this crucial time period. This first, crucial, hour is also known as the “Golden Hour.”

Statistics also shown that on the average 11 people die and 2250 suffer disabling injuries every hour of the day in the US, such costing roughly 54 million dollar per hour.

About 60% of the 94 million people unintentionally visiting emergency rooms each year are not able to communicate properly to their rescuers at the scene of an accident, in the emergency room, or the like. In some instances, communication cannot be done at all. Many victims do not have any personal data (medical history or data) available in order to receive the proper treatment.

This miscommunication is due to the lack of a personal/medical identification system that people should wear at all times. All major health care organizations are now urging all individuals to wear some type of an identification means to alert medical personnel of a person's condition.

The identification can be worn by “healthy” people as a precaution, similar to the obtaining of car or home insurance and/or the wearing of seat belts.

For the “not-so-healthy” people, wearing or having some accessible form of identification is especially needed, preventing mistakes made with the use of the wrong medication and/or interacting between medication combinations.

The percentage of people wearing such identification devices for this “GOLDEN HOUR” is believed to be, unfortunately, in the very low single digits.

Another problem with medical information is the right to privacy. Much concerns exists today with respect to the confidentiality of medical records, and the ability of medical providers, and other caretakers of such medical records, e.g., electronic data, paper files, etc. Because of these concerns, many people to date are reluctant to wear currently available identification devices due to the risk that such “private”information may be seen by unauthorized persons.

Accordingly, there is a need to improve the manner in which victims are able to provide up-to-date medical information to personnel, both in emergency and non-emergency situations.

One remedy to date is the use of smart health card ID programs such as the one described in the website www.healthsmartcard.net. Another example of a smart card manufacturer is Precis, with their website www.precisscs.com/products/healthcare.html providing additional detail of their products and services. These cards are similar to credit cards and carry electronic information of a person's medical history or condition. The cards can be read by a reader at different sites, e.g., doctor's offices, clinics, etc., to access the information on the electronic device contained on the card. For the most part, these programs are designed for people while they are conscious and thus able to give the card personally to the rescuer or doctor. In incoherent situations, this system is useless since no one is allowed to seek the card through a victim's wallet or purse, and thus cannot ascertain that there is a smart card available. Emergency medical personnel such as EMT's, paramedics, etc., are not allowed nor trained to search a victim for information, e.g., rifle through a victim's wallet or purse, due to the possible legal consequences of such an invasion of privacy.

The present invention solves this system by combining the primary medical information smart cards with a second medical information-containing electronic device, and the appropriate software and readers to allow the cards to contain the same information. The cards can then be used in tandem for updating information, and the second card can be used in emergency situations.

### SUMMARY OF THE INVENTION

In satisfaction of the foregoing objects and advantages, the present invention provides a system which provides a first or primary medical information smart cards with a second medical information-containing electronic device. Each card has an electronic read/writable electronic device capable of storing information, particularly medical information. Also provided is a reader/writer having a pair of slots to write non-medical information on both cards by a user of the cards. The writing of the non-medical information is supported by a home computer or access to a website, each having the software allowing for altering the non-medical information on each card. The system also utilized a similar reader/writer at a doctor's office, hospital, or clinic, and software on a computer to read and write information on the cards, both medical and non-medical. In each instance, the reader/writer must read both cards in order for the information to be written onto the cards.

The primary card can be stored in a user's wallet, pocketbook, purse or other holding mechanism. The secondary card is displayed on the user via a bracelet, necklace, or on a pendant and stored in a readily accessible place such as a shoe pocket.

In addition, another emergency situation reader is provided that is designed to at least read emergency information made available on the secondary card. The secondary card is designed to have an emergency block of information that can be read when the user cannot relay information because of trauma or the like. The emergency information would be read by one or more medical personnel using the emergency situation reader. The medical personnel then know immediately if the victim has any medical conditions that warrant special treatment.

The emergency information reader can be found in an ambulance, can be carried as a portable reader by an EMT, or can be part of a cellular telephone. If the emergency situation reader is a cell phone, the cell phone can also be programmed to transmit the read information to the appropriate medical facility for analysis or preparation of the incoming victim. The cellular telephone can also be adapted with two slots to read the primary card if need be.

The method of the invention involves providing the primary and secondary medical information containing electronic cards and allowing a user of each to change or alter non-medical information. The cards are used together to change the non-medical information, and also used together when medical information is inputted by an appropriate medical person such as a doctor or the like.

Once the information is on each card, the secondary card is carried by a user in a manner to allow medical personnel to access the secondary card without invading the user's privacy. In this way, emergency information contained on the card can be accessed using a reader adapted to read that information where the user/victim may be located, a car crash scene, etc.

Another aspect of the invention is the ability to use the secondary card as a medical information carrier for inanimate items such as medical transport tags, blood transport tags, organ donor transport tags, or the like in conjunction with patient movement. The secondary card and holder or carrier could also replace an in-hospital patient wrist band, whereby a nurse or other medical personnel would insert the secondary card in a reader to ascertain information about the patient or instructions as to how the patient should be treated.

In another embodiment, when a patient is in a medical facility with a wristband having the SID, and extra copy of the patient's information can be stored on another SID, and this SID can be attached to an inanimate object associated with the patient, e.g., a blood bag, organ container, or the like. In this instance, the medical facility would have a read/write device capable of at least copying the information on the patient's wristband onto another SID for attachment to the inanimate object.

More particularly, the invention includes a system for providing medical information in emergency and non-emergency situations comprising a medical information-containing electronic device and a carrier for storing the medical information-containing electronic device. The medical information pertains to the inanimate object such as organs being transported for transplant, blood containers, medical supplies, etc.

The system also includes a read/write device for reading and/or writing information on the medical information-containing electronic device, and a computer system for each read/write device for controlling the type of information that can be read and/or written on the read/write devices,

A read device for reading information on the medical information-containing electronic device is also provided as is a means for attaching the carrier to the inanimate object so that medical information about the inanimate object can be obtained by using the read device.

### BRIEF DESCRIPTION OF THE DRAWINGS

Reference is now made to the drawings of the invention wherein:

FIG. 1 is a schematic representation of one embodiment of the invention;

FIG. 2a shows the one portable reader for the LID and SID of the invention;

FIG. 2b shows a spring loaded hand reader;

FIG. 2c shows exemplary SIDs;

FIG. 3 is a schematic flowsheet of the inventive system for home and medical office use;

FIG. 4 is a schematic flowsheet of the system when used in an emergency;

FIG. 5 is an example of another portable reader;

FIG. 6 shows the SID with a carrying bracelet; and

FIG. 7 shows a contactless SID card system.

### DESCRIPTION OF THE PREFERRED EMBODIMENTS

In one aspect of the invention, primary medical information smart cards are supplemented with an extra (but very small) second medical information-containing electronic card. In addition, a medical information-containing electronic card reader/writer system is provided with the following:

1. A software program with a smart card reader/writer for individual and personal use. The program is designed to read and write to a primary medical information-containing electronic card, preferably the same size as normal wallet cards, hereinafter called a “LID”. (Large ID

2. A secondary medical information-containing electronic card, in the way of the foldable or miniature medical information-containing electronic card, called “SID” is also provided. (Small or SOS ID)

The software program is simple and should be a part of a widely used operating program like Windows or the like. The program should also be simple for the owner of the cards, and the doctor, emergency room or hospital personnel and equipment. Since reader/writer devices and software are readily available, designing the configuration and hardware of the devices themselves as well as the software to read and write are well within the skill of the artisan.

Referring to FIG. 1, both the LID 1 and the SID 3 cards are written by the owner/wearer him/herself (or caregiver, family doctor) by filling in information on the home computer screen 5 form which than is written to both cards. However, if information is to be changed or added, both cards have to be in the reader 7 for security reasons and to make sure data is the same on either one card providing the owner with security in both situations, i.e., for “conscious” or non-emergency times as well in “unconscious” or emergency times. If the doctor is merely reading information, then only one card is needed for the reader.

The reader/writer 7 of this invention should have two slots, slot 9 for the normal LID card 1 (large size) and one slot 11 for SID card 3 (small size). The chip on the LID 1 or SID 3 is preferably the same type used on smart cards that are 54×86 mm, i.e., an EEPROM. The chip could employ a security lock such as a metal cap when using a round metal capsule with a removable lid.

The LID card 1 (carried in wallet/purse) alone can be used when scheduled visits are made to the physician's office or hospital, thus when communication between the care-seeker and caregiver is ‘normal’ or non-emergency. Again, if the information is to be read only, the LID can be used. IF information is to be changed, the cards 1 and 3 are both updated with the results of this visit by the doctor and using the doctor's reader/writer. The medical information is written on the cards 1 and 3 in a fashion so that it cannot be erased, edited, or altered, by the cardholder using the home computer 12. The physician or doctor can only update the cards with respect to medical information. The medical information on the cards 1 and 3 can only be read, not updated, by the wearer, or other person needing to access the information on the SID in an emergency situation.

As mentioned above, it should be understood that the software program to allow the cards to be edited in dual fashion for updating personal information and the like can be easily developed by one skilled in the art. Similarly, the safeguards necessary to allow only changing of non-medical information at the home computer is also well within the skill of the artisan. The reader/writers are also believed to be well known in terms of accessing the information on the cards, as well as rewriting information depending on the authority of the rewriting author. For example, a doctor's office or clinic would have a reader/writer that would allow updating or adding medical information, whereas the reader/writer at a user's home would allow only simultaneous updating of the non-medical information. In either instance, the reader requires a slot for each card to update the electronically stored information so that accessing either card provides the same information to a person seeking the medical information.

Accidentally attempting to write to one card if the other card is not inserted in the appropriate reader/writer is normally blocked by the reading/writing software so that information critical to an individual cannot be put on one card, e.g., the LID, but not the other card, the SID. In other words, both cards must be available for writing in non-emergency situations so that both cards are always kept current. If either card is lost, the owner must then obtain a new card from a doctor or other authorized person/entity, and the new card can then be updated with the current information for later use.

The SID card 3 (carried in a shoe-pocket, as pendant/bracelet or the like) offers the information that is so vital in the “Golden Hour.” This information can only be read using a reader operated by emergency crews or the like when the wearer is not communicating properly i.e. during emergencies, car accidents, falls from elderly, children being hurt, Alzheimer's wandering patient, diabetes episode, epilepsy, heart conditions, etc.

The reader operated by emergency personnel differs from the reader in FIG. 1 in that only the SID card 3 is needed for operation. This SID card 3 should have only data displayed that is needed in an emergency situation where ambulance crews need to know about allergies, currently medications taken, last tetanus shots, family doctor's phone #, next of kin, etc. Of course, the medical personnel reader could also have a slot to read the LID if the victim is conscious.

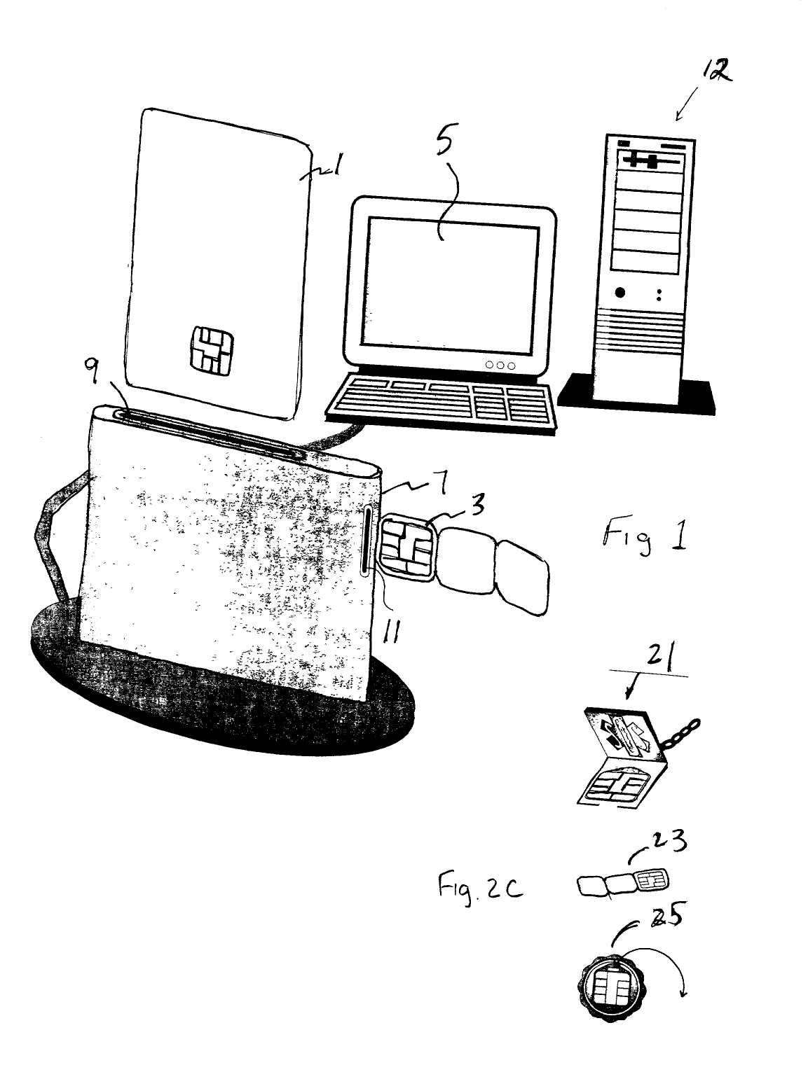

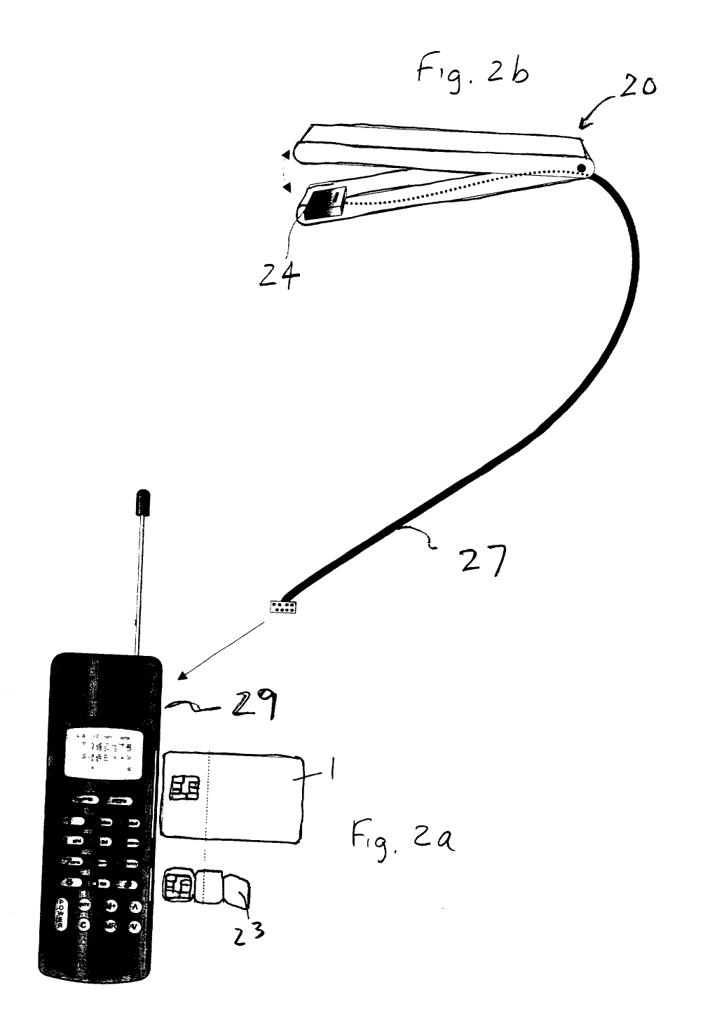

In another embodiment of the invention, the SID card can be used with a portable-, or cell phone of emergency crews. Referring to FIG. 2a, the phone 29 could be a two (or at least one) slot phone capable for reading the SID card 3. This “portable” program is the read-only part of the same software as mentioned above for emergency situations using a stand alone reader.

Reading the SID card 3 can display the data on the EMT's handheld phone screen. With this information, the EMT can start proper ways to stabilize the person. The phone can be programmed to transmit the information on the SID 3 to prepare for this, soon to be, wheeled-in victim, while the EMT is stabilizing the person. An audio message could also be provided.

When the ambulance crew comes to the aid of a victim: a fall, car crash, Alzheimer's wandering patient or a diabetes during a “episode”, the medical personnel can easily find the small SID locket 3 (on the neck, on the wrist or on the shoe pocket) and is able to insert the chip part into his phonereader. At this time, the EMT can call the local hospital and the victim's information is transmitted without time delay, and the appropriate medical personnel can take steps to save the life of the patient, or read the displayed information and call separately, or administer the proper treatment or medicine.

The invention is advantageous in that it can drastically reduce the, sometimes fatal, communication gap between care-seeker and caregiver in emergency situations. The inventive method and system will increase faster pre-hospital treatment and decrease mistakes and guesses as well as drastically decrease the overall cost factor.

In yet another embodiment, the SID 3, being small and in plastic, could be used for many other purposes, e.g., an attachment to an item such as a stapled medical-transport tag, or a blood-transport tag, or an organ-donor-transport tag, and/or be attached to any “in-hospital” patient's wrist as base to these transport tags, (plastic bracelet type-tag) for control of medications by nurses with the same handheld display computer. In this instance, a patient could have one SID, and another SID could be attached to the inanimate object, the other SID having the same information as the one associated with the patient. In the scenario, the medical facility would have a read/write device capable of copying the information from the wristband to the other SID so that the same information is on each.

While bar-code tags are already in use for providing readable information, an electronic chip is advantageous since it is re-writable (cost free after time) while a plain bar code sticker is not; the bar code tag has to be bought again. If a patient in the hospital has a wrist-SID-chip, her blood work goes to the lab with a copy of her personal SID-chip. This is the most secure way for the blood work to come back to her.

In these instances, the SID chip would be employed in non emergency or emergency situations, e.g., in place of a patient wrist band, or as a tag for an item being transported from one place to another, etc.

FIG. 2b also shows a hand held tweezer/reader 20 that would allow medical personnel to read one of the secondary cards 21, 23, or 25 shown in FIG. 2c. Information read by reader 20 can be input via line 27 to a cell phone 29 of FIG. 2a, or the reader/writer of a home computer (FIG. 1) or the system found in a doctor's office.

The handheld reader 20 pivots so as to bring reading head 24 into contact with the appropriate portion of the electronic chip found on the SID card for reading. While the reading head 24 is shown on the lower arm of the handheld reader, the head could be positioned on the upper arm as well.

In yet another embodiment, a user, home or doctor could log onto a website for the necessary software for reading/writing.

While a cell phone is shown, the information could be input to a personal digital assistant (PDA) for display of the information, and even transmission thereof if the PDA has transmitting capability.

The phone 29 of FIG. 2a is shown with two slots, one to receive the primary card if the victim is coherent, and another one to receive the secondary card if the victim is incoherent or unconscious. The dashed line in FIG. 2a shows the extent of the SID or LID insertion.

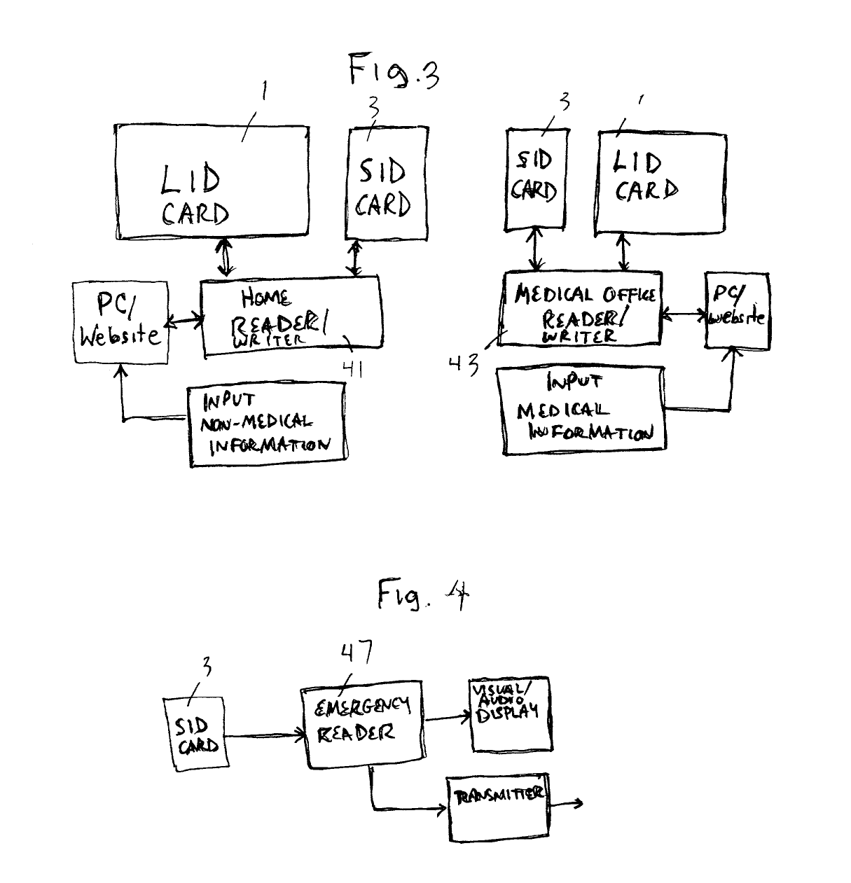

FIG. 3 shows an arrangement 40 for the reader/writers 41 and 43 for home and medical environment use, respectively. As noted above, the user's own PC could have the read/write software, or the PC could access a website for such software. Similarly, the medical environment, characterized in FIG. 3 as a medical office reader/writer could use a computer or website for software access. Although the reader/writer 43 is designated as a medical office, it can be located in any setting where the SID and LID cards would be accessed for obtaining or changing medical information on the cards.

FIG. 4 shows an arrangement whereby the SID card 3 is used in an emergency situation reader only 47, such as one that would be on board an ambulance, carried by EMT's, or the like. The emergency reader can also be the cell phone described above. The reader has a display to allow the medical personnel to either see or hear the information found on the SID. The reader can also have transmission capabilities for sending the information on the SID to a remote location if necessary. The transmitter can be in the form of a cell phone, or even a modem device.

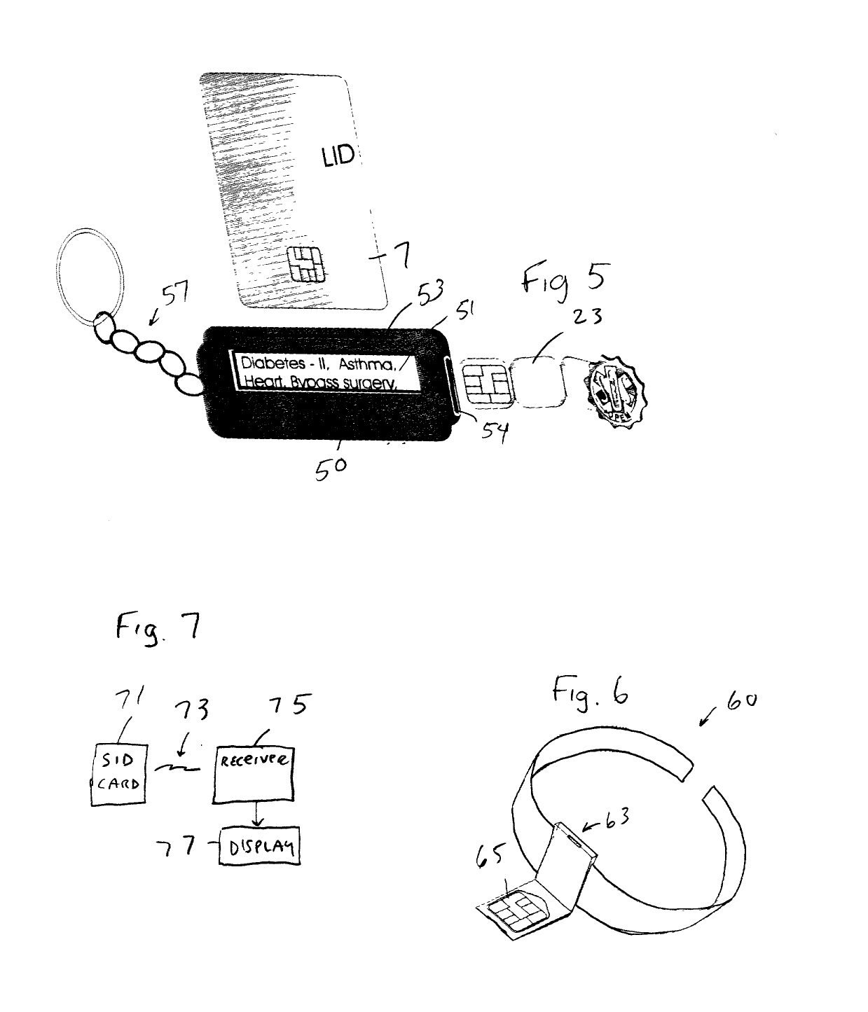

In another embodiment as shown in FIG. 5, a portable reader 50 can be employed as is commonly used in connection with smart cards. As an example, these readers have a display screen 51 that would display 51 the amount of money left on a gas company smart card. According to the invention, the reader 50 would have a slot 53 for the LID 1, and a second slot 54 for the SID 23. In this way, either card 1 or 23 can be used to display the appropriate information in the display 51. The reader 50 can have means such as a chain 57 to keep it attached to a user's person or another article associated with the person such as a shoe or the like, while still being exposed and accessible for use. The reader 50 could have a marking as the locket for indicating a medical function.

Another embodiment of the invention is shown in FIG. 6 wherein the SID is attached to a bracelet 60. In this mode, the SID 63 can be opened similar to the SID 21 of FIG. 2c, and the bracelet 60 can be manipulated so that the chip 65 on the SID can be accessed for reading/writing. In this embodiment, the SID could function as a passenger (airline passenger for example) identifier that would permit a passenger to enter a particular area if the SID 63 had the proper information, and bar a passenger from entering another area due to a lack of authorization via the SID 63.

While the primary and secondary cards could have a number of sizes and shapes, it is preferred that the primary card be in the shape of a credit card, and the secondary card be that shown in FIGS. 2a-c. The locket features are shown in applicant's related United States Design Patent No. D432,939, and a shoe pocket for holding the secondary card is shown in United States Design Patent No. 410,694, each incorporated by reference in their entirety. Other features of the locket are disclosed in applicant's co-pending application Ser. No. 09/277,181, hereby incorporated by reference in its entirety.

In yet another embodiment of the invention, the LID or SID could employ a contactless electronic device for storing the necessary information. These contactless devices rely on an RF device that sends a radio frequency or other signal to the contactless device to obtain the stored information without having to have a physical contact between the device and a reader. FIG. 7 shows a SID card 71 capable of sending a signal 73 to a receiver 75 for display of the information being sent. For example, the SID when attached to a blood bag or an organ container could have a contactless device so that the information could be more easily read. As another example, the SID of FIG. 5 could be modified to transmit the information to the reader 50 rather than employ the slot 54 for information transfer. These contactless devices alone are known in the art, as are the devices used to obtain the information using a signal such as a radio frequency or the like. Thus, a further description of the details of these types of devices is not necessary for understanding of the invention.

As such, an invention has been disclosed in terms of preferred embodiments thereof which fulfills each and every one of the objects of the present invention as set forth above and provides new and improved system and method using medical information-containing electronic devices using medical information-containing electronic devices in emergency and non-emergency situations.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. A method of providing medical information in emergency and non-emergency situations comprising:
a) providing a first medical information-containing electronic device;
b) providing a second medical information-containing electronic device, and a means for carrying the second device such that the second device can be accessed by medical personnel if a user is incapacitated;
c) maintaining the same medical information on each of the first and second devices;
d) simultaneously reading or writing non-medical information or medical information on the first and second devices in a non-emergency situation, and reading information on the second device in an emergency or non-emergency situation.

2. A system for providing medical information in emergency and non-emergency situations comprising:
a) a first medical information-containing electronic device;
b) a second medical information-containing electronic device, and a means for carrying the second device such that the second device can be freely accessed by medical personnel if a user is incapacitated; and
c) at least a pair of read/write devices for simultaneously reading and/or writing information on each of the first and second devices so that each device has the same medical information thereon, and a computer system for each read/write device for controlling the type of information that can be read and/or written on the read/write devices, one read write device and computer system designed to allow for writing of non-medical information only, and the other read/write device and computer system designed to allow for writing both medical and non-medical information.

3. The system of claim 2, wherein the means for carrying includes a bracelet for the wrist, a necklace for the neck, and a locket to be carried in a shoe or other clothing.

4. The system of claim 2, wherein the second device is read using a medical personnel reader when the user is incapacitated and cannot produce the first device, and the information read is one of displayed, played aloud, or transmitted to a remote source for reading or a combination thereof.

5. The system of claim 2, wherein the second device is attached to a person's wrist, the medical information on the second device relating to the person, and the information is read using a medical personnel reader in a non-emergency or emergency situation.

6. A system for providing medical information in emergency and non-emergency situations comprising:
a) a medical information-containing electronic device and a carrier for storing the medical information-containing electronic device, the medical information pertaining to one of an the inanimate object or a patient; and
c) a read/write device for reading and/or writing information on the medical information-containing electronic device, and a computer system for the read/write device for controlling the type of information that can be read and/or written on the read/write devices,
d) a read device for reading information on the medical information-containing electronic device; and
e) a means for attaching the carrier to one of the inanimate object or patient so that medical information about either the inanimate object and/or the patient can be obtained by using the read device.

7. The system of claim 6, comprising at least a pair of medical information-containing electronic devices, one to be worn by the patient, and one attached to the inanimate object, each containing the same information about the patient.

8. The method of claim 1, wherein the means for carrying includes a bracelet for the wrist, a necklace for the neck, and a locket to be carried in a shoe or other clothing.

9. The method of claim 1, wherein the second device is read using a medical personnel reader when the user is incapacitated and cannot product the first device, and the information read is one of displayed, played aloud, or transmitted to a remote source for reading or a combination thereof.

10. The method of claim 1, wherein the second device is attached to a person's wrist, the medical information on the second device relating to the person, and the information is read using a medical personnel reader in a non-emergency or emergency situation.

11. The system of claim 2, further comprising a medical personnel reader capable of reading the first device, the second device, or both.

12. The system of claim 11, wherein the medical personnel reader is a cell phone capable of transmitting the read information, a portable reader with a display for displaying read information, or a reader than employs a spring loaded reading head.

13. The method of claim 1, wherein a medical personnel reader is used in the step for the reading the second device, the medical personnel reader capable of reading the first device, the second device, or both.

14. The method of claim 13, wherein the medical personnel reader is a cell phone capable of transmitting the read information, a portable reader with a display for displaying read information, or a reader than employs a spring loaded reading head.

15. The method of claim 1, wherein the reading of information on the second device is performed by transmitting information using a signal.

16. The system of claim 6, wherein the medical-information containing device transmits the information to the read device for reading using a signal for transmission.

17. The system of claim 4, wherein the reading using the medical personnel reader is performed using a signal from the second device.

18. The method of claim 1, wherein the means for carrying is one of a foldable locket, a locket with an extendable support, and a metal capsule having a lid.

19. The system of claim 2, wherein the means for carrying is one of a foldable locket, a locket with an extendable support, and a metal capsule having a lid.

20. The system of claim 6, wherein the means for carrying is one of a foldable locket, a locket with an extendable support, and a metal capsule having a lid.

21. The system of claim 7, wherein the inanimate object is a tag associated with one of a medical record and a medical sample container.
